(19) United States
(12) Patent Application Publication
(10) Pub. No.: US 2004/0143505 A1
(43) Pub. Date: Jul. 22, 2004

(54) Method for tracking and disposition of articles

(76) Inventor: Aram Kovach, Lewis Center, OH (US)

Correspondence Address: Michael A. Forhan, Esq., Thompson Hine LLP, Suite 700, 10 W. Broad St., Columbus, OH, 43215-3435, US

(21) Appl. No.: 10/687,429

(22) Filed: Oct. 16, 2003

Related U.S. Application Data
(60) Provisional application No. 60/418,916, filed on Oct. 16, 2002.

(51) Int. Cl. G06F 17/60

(52) U.S. Cl. 705/23

(57) ABSTRACT

A method is disclosed for selling and tracking merchandise using Radio-Frequency Identification (“RFID”) tags. The RFID tag typically contains an electronic microchip, which may be permanently attached to a substrate containing a small planar antenna. Each RFID tag is tuned by the manufacturer to operate at a specific frequency and with a unique identifier number. A “scanner” device, which provides a temporary source of power to the RFID tag by means of a Radio Frequency (“RF”) field, also provides a means for transmitting data to the RFID tag for storage within a static memory portion of the microchip. The microchip is also capable of communicating the RFID tag's identifier number and any data stored on the microchip to a receiver portion of the scanner when interrogated. The RFID tag may be installed into devices and merchandise as a theft-deterrent and an inventory tracking tool.

### This application claims priority to U.S. provisional application 60/418,916, filed Oct. 16, 2002, the contents of which are hereby incorporated by reference.

### FIELD

The present invention relates to a method the tracking and disposition of articles. Specifically, the present invention relates to a method for the tracking and disposition of merchandise within a retail store environment.

### BACKGROUND

Retail stores face a number of challenges with regard to selling merchandise to the general public. For example, busy sales clerks may lose sales because they are not available to service customers and/or engage in suggestive selling. In addition, there is a desire to make the checkout process as rapid and convenient as possible in order to accommodate today's busy lifestyle. Many shoppers do not have the time or patience to wait in long lines to purchase their selections and may decide not to shop at all when faced with such delays. Long checkout lines can be particularly vexing during the holiday season or during special sales events. Large numbers of potential sales are lost during these periods due to customers who decide not to wait in line and who may choose to shop by mail or via the internet to avoid the frustration.

In addition, as workforce and other overhead expenses rise, there is an increasing desire to maximize store efficiency and minimize the number of employees needed. Stores continually seek to streamline their business models to eliminate activities that do not add to the store's revenues. One such activity is taking regular inventory of stock. Regular inventories are frequently needed for accounting purposes and to facilitate ordering of replacement stock. Another trend is self-service, as can be seen by the increased popularity of pay-at-the-pump gas stations and self-serve grocery checkout lines.

Further, there is a desire to minimize losses due to merchandise theft. A common type of theft is that of “shoplifting,” wherein a customer conceals merchandise on his or her person and then leaves the store without paying. Another type of theft is “shrinkage” or “pilfering,” which occurs when the store's employees take articles from the store without paying for them. Pilfering is particularly troublesome, since dishonest employees are usually aware of any security precautions utilized by the store and how to avoid detection. Also, such employees usually have ample time to secret away goods and take them from the store at an opportune time. A more serious form of theft involves burglary or robbery, where large quantities of merchandise may be taken.

Various preventative methods have been developed to reduce losses from theft. For example, small containers filled with staining inks have been attached to expensive clothing to discourage theft. The containers are designed to spill, ruining the clothing if removal is attempted without the use of a special tool. Another anti-theft device utilizes magnetic strips attached to the merchandise. If not removed or disabled by a sales clerk at the time of purchase, an alarm sounds when the customer passes through a sensing loop positioned near the store's entrances and exits. While effective to a degree as a theft deterrent, these devices require the intervention of store personnel to remove or disable them at the time of purchase and do nothing to help automate other aspects of the retail function.

There is a need for a faster, more convenient means for purchasing goods from a retail store. There is a further need to streamline the inventory process. Yet another need exists to minimize stock losses due to theft.

### SUMMARY

The present invention provides a method for selling and tracking merchandise using Radio-Frequency Identification (“RFID”) tags. An example RFID tag is the DURA-LABEL® tag manufactured by Single Chip Systems Corporation of San Diego, Calif. Alternative RFID tags and associated systems manufactured by others may likewise be satisfactorily utilized with the present invention.

An RFID tag typically contains an electronic microchip, which may be permanently attached to a substrate containing a small planar antenna. Each RFID tag is tuned by the manufacturer to operate at a specific frequency and have an electronically stored, unique identifier number. The RFID tag may also electronically store additional information relating to the merchandise to which it is affixed, such as manufacturing dates, serial numbers, lot runs, and origin of manufacture.

The information electronically stored on the microchip of the RFID tag is read via an external Radio Frequency (“RF”) field provided by a “scanner” device, which also provides a means for transferring data to the microchip. RFID scanners are well-known in the art. An example is the INSTASCAN® RFID Scanner manufactured by Single Chip Systems Corporation of San Diego, Calif. Alternative RFID scanners and associated systems manufactured by others may likewise be satisfactorily utilized with the present invention.

A memory portion of the RFID tag facilitates storage of data by static means, eliminating any need for batteries or other “keep-alive” power sources. In finished form the RFID tag is small, rugged, and unobtrusive, allowing it to be permanently installed into devices and merchandise by any number of convenient means. For example, the RFID tag may be sewn into the hem or seam of clothing without adverse effect to either the clothing or the RFID tag. The RFID tag may also be affixed inside any number of objects, such as electronic equipment and small appliances. The RFID tag may also be placed within the packaging for a wide variety of valuable articles, or even made part of the labeling for certain products such as perfumes. In one embodiment, a microchip is integrated into an optically coded label, enabling it to be read by either optical or RF scanning devices. The low cost of the RFID tag makes its use practical for use on all but the lowest-priced commodity articles.

Installing the RFID tag into merchandise provides retailers with a new tool for facilitating faster checkout, suggestive selling, automating inventory management, and preventing theft.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a top plan view of an example RFID tag;

FIG. 2 is a flow diagram of a method for selling and tracking merchandise according to an embodiment of the present invention; and

FIG. 3 is a flow diagram of a method for monitoring inventory and detecting theft of tagged merchandise according to an embodiment of the present invention.

### DETAILED DESCRIPTION

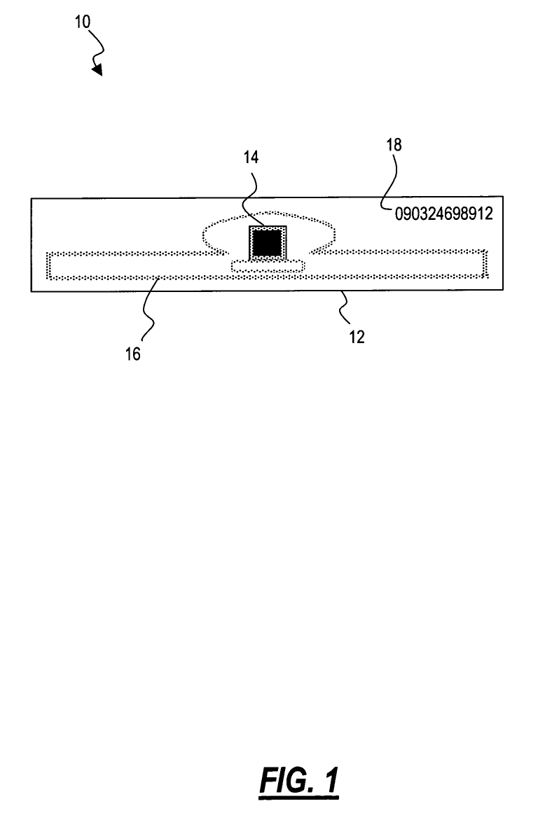

The general arrangement of one type of conventional RFID tag 10 usable with the present invention is illustrated in FIG. 1. RFID tag 10 is typically assembled on a flexible substrate 12, such as a plastic film. A microchip 14, permanently affixed to substrate 12, comprises a memory portion (not shown) adapted to electronically store data. Microchip 14 further comprises an RF-powered transmitter/receiver portion (not shown) to enable storage and retrieval of data from the memory portion by means of RF energy. A planar antenna 16 is permanently affixed to substrate 12, and is electrically coupled to the transmitter/receiver portion of microchip 14. Each RFID tag 10 may have a unique identifier number 18 to distinguish it from other RFID tags 10, or can be encoded with product-specific identifiers such as the item's “SKU” number by writing the data into the memory portion of microchip 14 via a scanner.

In operation, microchip 14 of RFID tag 10 is powered by an external RF field provided by a corresponding interrogating scanner (not shown). The interrogating scanner also electrically communicates with RFID tag 10 to write data to the memory portion of microchip 14 and/or retrieve data stored on the memory portion.

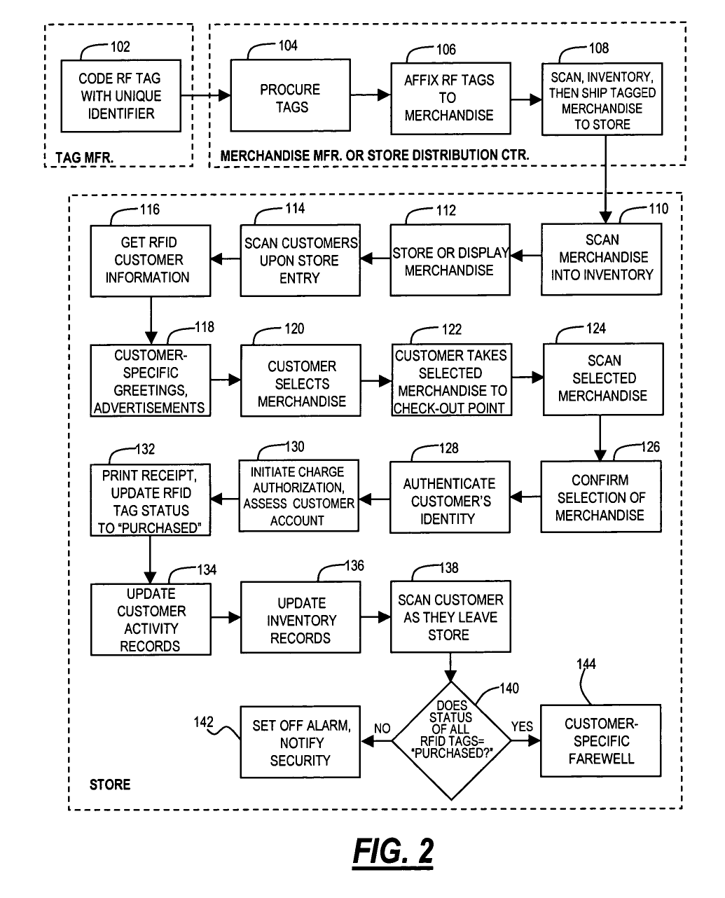

Referring now to FIG. 2, with continued reference to FIG. 1, a flow diagram of a method for tracking and dispositioning articles, such as merchandise, is shown according to an embodiment of the present invention. At step 102 each RFID tag 10 is coded with a unique or a series of unique identifiers, such as a numeric or alphanumeric string 18, by the manufacturer of the RFID tags. RFID tags 10 are then acquired by either a merchandise manufacturer or a store distribution center at step 104, and at step 106 the RFID tags are integrated into or otherwise affixed to merchandise which is to be tracked. For example, an RFID tag 10 may be sewn into a seam or hem of a clothing article, made part of the packaging or labelling for a general merchandise article, or molded within an article. Alternatively, RFID tags 10 may be added to the merchandise at the retail level, if appropriate and convenient given the nature of the goods.

At step 108 the tagged product may be scanned and inventoried as appropriate to the needs of the merchandise manufacturer or store distribution center. For example, the manufacturer may electronically store within the memory portion of microcontroller 14 data pertaining to the merchandise, such as date/lot codes, inspection records, run numbers, manufacturing location, and product design and/or configuration data. The merchandise is then shipped to the next point of distribution, such as a retail store.

Upon receipt at the store at step 10, the merchandise is placed in proximity to a scanning device (not shown) which scans RFID tags 10 associated with the merchandise to obtain the RFID tags' identifier numbers and any other pertinent information stored on the microchips 14. The scanner is able to read the stored information from unique RFID tags 10 as a group, eliminating the need to individually pass merchandise through the scanner. Thus, the scanner may be conveniently placed at the receiving entrance or dock for the store, such as near the door frame. Packages shipped at step 108 are simply transported within range of the scanner, which automatically detects and reads the entire inventory of merchandise within the sealed shipping container using the RFID tags 10. This information may be automatically transmitted to a computer system within the store at step 110 in order to update the inventory records with the information read from the RFID tags. The store may also write data into the memory portion of microchip 14 via a scanner, such as setting a status or condition code of the merchandise to indicate that the associated merchandise is “unsold” or whether the item is on sale. The unsold status or condition code may be utilized to detect and deter theft, as will be discussed in greater detail below.

At step 112 the merchandise is placed into any convenient stocking area, or taken to the display portion of the store. If appropriate, scanners may be deployed at key traffic locations within the store to trace the movement of the merchandise within the store prior to its leaving the store. This may be helpful in providing store management personnel with information regarding missing inventory, whether the merchandise has left the store through any of the store's exit points and its purchase status at those points, and assist sales personnel by triggering suggestive selling at kiosks.

As previously noted, RFID tag 10 is small and designed to be quite rugged. As such, it may be made an integral part of a credit or debit card. When a customer enters the store at step 114, a scanner placed at the store entrance detects such a credit or debit card being carried by the customer and reads the identifier and any other pertinent information residing on the card. This data is sent to a computer system at step 116, which matches the identifier number to a pre-existing customer record. The customer record may include credit account numbers, shopping habits based on prior purchases, and frequency of visits to the store. The computer system may be a standalone unit operating autonomously; alternatively, the computer system may be part of an internal and/or external network of computers.

A display or computerized voice messaging system may be utilized at step 118 to offer the customer a personalized greeting and inform them of any sales or new items that fit within the customer's shopping habits, preferences, and tastes as determined by the record obtained at step 116. Similarly, the display or computerized voice messaging system could provide the customer with directed advertising, such as making suggestions regarding compatible and/or matching merchandise available to augment recent purchases, as determined by the record of step 116. The display or computerized voice messaging system could also inform the customer about merchandise found to be popular with other purchasers having shopping habits, preferences, and tastes similar to those on record for the customer.

As the customer moves through the store, he or she selects merchandise and either carries it or places it into a shopping cart, as indicated by step 120. When finished, the customer moves to a self-service checkout point as shown by step 122. The self-service checkout point may take a variety of forms, such as a counter, desk, station, kiosk, stand, or table. At step 124 the scanner reads the RFID tags of the articles presented by the customer, and at step 126 a listing of the articles appears on a display or print-out for the customer to review for accuracy. The identity of the customer is then verified at step 128 by any convenient means, such as entry of a personal identification number (“PIN”), voice recognition, face recognition, retinal identification, fingerprint identification or any other biometric, any of which can be used in conjunction with the RFID tag data read from the customer's credit or debit card at step 116.

Once the customer confirms the accuracy of the bill and has verified their identity, charges for the purchases may be assessed directly to the customer's account at step 130, using account information obtained at step 116. The customer may also pay for part or all of the purchase price by other means, such as by check, money order, cash or any other negotiable instrument. The RFID tags 10 for the purchased articles may be scanned again at step 132 to store data in the memory portion of microchip 14, indicating that the merchandise to which they are integrated or otherwise affixed have been purchased. The customer may also be provided with a printed receipt at this step. The customer's record is updated at step 134 to add the new purchases.

The customer's purchases are noted in the computer system's inventory system at step 136. During this step the RFID tag identifiers for the articles purchased are removed from the store's electronic inventory records, maintaining a “real-time” status of all merchandise in the store. When the customer leaves the store at step 138, scanners placed at the store's entrances and exits scan the customer and his or her bags for any RFID tags 10. The RFID tags 10 are read at step 140 to check the purchase status of the merchandise. If any RFID tags 10 are read as having an “unsold” status or condition code status, a perceivable alert signal such as an audible alarm, flashing lights and automatically-locking exit doors may be engaged and security personnel may be notified at step 142. If no unsold RFID tags are detected, the customer may be given a customer-specific thank-you and/or farewell message by a display or computerized voice messaging system, as shown by step 144.

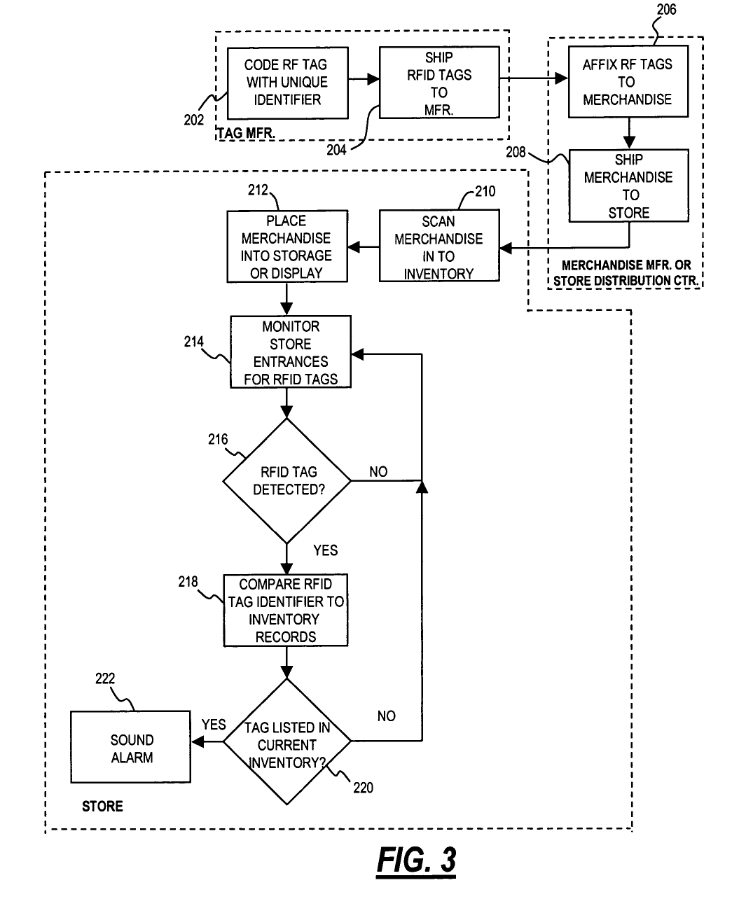

Referring now to FIG. 3 in combination with FIG. 1, a method for detecting theft of merchandise according to an embodiment of the present invention is depicted. At step 202 each RFID tag 10 is coded with a unique identifier, such as a numeric or alphanumeric string 18, by the manufacturer of the RFID tag. The RFID tags 10 are then shipped to a merchandise manufacturer or store distribution center at step 204, and at step 206 the RFID tags are integrated into or are otherwise affixed to merchandise which is to be tracked. For example, an RFID tag may be sewn into a seam or hem of a clothing article, made part of the labelling or packaging for a general merchandise article, or molded within the article. Alternatively, RFID tags 10 may be added to the merchandise at the retail store, if appropriate and convenient given the nature of the goods. The tagged product is shipped to the next point of distribution, typically a retail store, at step 208.

Upon receipt at the store at step 210, the collective merchandise may be placed in proximity to a scanning device as a group. The scanner reads each RFID tag's 10 identifier number and any other pertinent information stored on the microchips 14. The scanner is able to read the stored information from the RFID tags as a group, eliminating the need to pass individual articles of merchandise through the scanner. Thus the scanner may be placed at the receiving entrance or dock for the store, such as near the door frame. Packages shipped at step 208 are simply carried near the scanner, which automatically detects and reads the RFID tags of all merchandise contained in the sealed shipping container. This information is automatically transmitted to a computer system (not shown) within the store at step 210 in order to update the inventory records with the information read from the RFID tags 10. The store may also write data into the memory portion of microchip 14 via the scanner, such as setting a status or condition code of the merchandise to indicate that the associated merchandise is “unsold.” This status or condition code may be utilized to deter theft, as will be discussed in greater detail below. The merchandise is placed into any convenient stocking area, or taken to the display portion of the store at step 212. If appropriate, scanners may be deployed at key traffic locations within the store to trace the movement of the merchandise within the store, prior to its leaving the store. This may be helpful in providing alerting store management personnel with information regarding missing inventory and whether the merchandise has left the store through any of the store's exit points.

Once the merchandise is added to the store's inventory at step 210, it becomes protected. At steps 214, 216 scanners placed at the store's entrances, exits, and receiving areas monitor for the presence of RFID tags 10. If an RFID tag 10 is detected, the scanner sends the RFID tag's identifier data 18 to the store computer system, where at step 218 the RFID tag's data is checked against the store's list of unsold merchandise. If the identification data 18 of the scanned RFID tag is not listed as part of the store's unsold inventory at step 220, no alert signal is engaged. However, if the merchandise carrying the RFID tag 10 is listed as part of the store's unsold inventory, a possible theft is deemed to be in process and a perceivable alert signal such as an audible alarm, flashing lights and automatically-locking exit doors may be engaged, as indicated by step 222. Step 222 may include alerting security personnel. As a further precaution against pilferage, employees may be required to wear at all times a store name tag or identification badge containing an RFID tag 10 having stored information identifying the employee. With this information, one or more particular employees may be associated with the missing unsold merchandise, if the missing merchandise and the employee's RFID tags 10 are scanned closely together in time.

Although an RFID tag 10 will not directly prevent losses due to burglary and robbery, the ability to positively identify stolen merchandise can aid in the return of the stolen merchandise if the perpetrators are caught. In addition, the ability of law enforcement authorities to easily identify otherwise untraceable merchandise may reduce its value in the eyes of thieves due to the risk of detection. As a further safeguard, the computer and security systems of the store may include a record of stolen and missing merchandise. Customers entering the store with clothing or other articles having RFID tags 10 may be automatically scanned by scanners located at the store's entrances and exits. The computer system (not shown) may compare the identification data 18 of the scanned RFID tag 10 to the store's record of stolen and missing merchandise. If the identification number 18 of the scanned RFID tag 10 appears on the store's record of stolen and missing merchandise, the store's security force may be automatically alerted by the computer system and given a description of the merchandise. The store's record of stolen and missing merchandise may also be shared between units of a chain store, or even between unaffiliated stores and/or law enforcement as a further deterrent. This may be particularly useful for expensive clothing, such as leather or fur coats, where the RFID tag can be permanently affixed to an inaccessible portion of the clothing.

It should be noted that the present invention may be used to track and control the disposition of articles at any and all of the points of distribution for the articles, including, without limitation, component manufacturers, finished-article manufacturers, distributors, wholesalers, retail store distribution, retail store inventory, retail store sales, post-sale warranty, and post-sale service.

As can be seen, the disclosed method provides a more efficient and accurate means for selling and tracking merchandise in a retail store environment. The self-checkout's speed, novelty, and ease of use may result in increased sales. Further, the automated inventory control system provides increased efficiency, which may result in cost savings. Finally, the method of tracking merchandise helps to prevent stock loss due to theft.

While this invention has been shown and described with respect to several detailed embodiments thereof, it will be understood by those skilled in the art that various changes in form and detail thereof may be made without departing from the scope of the claims of the invention. One skilled in the art will recognize that many of the separately-described functions of the various embodiments of the present invention may be combined, rearranged or eliminated to accomplish the desired result without affecting the scope of the invention. The embodiments disclosed herein are for illustrative purposes only and are not intended to be limiting with regard to the arrangement or combination of the components of the present invention.

What is claimed is:

1. A method for tracking and disposition of articles, comprising the steps of:
a) coding at least one RFID tag with a unique identifier, the identifier being electronically stored in a memory portion of the RFID tag;
b) affixing at least one RFID tag to at least one article of merchandise;
c) electrically scanning a select RFID tag to obtain the select identifier;
d) communicating the select identifier to an inventory record of a point of distribution and incrementing an inventory quantity of the point of distribution;
e) electrically scanning the article of merchandise when it is scheduled to be removed from the point of distribution to obtain the select identifier from the RFID tag; and
f) removing the select identifier from the inventory record and updating the inventory record at the point of distribution to reflect the removal of the article of merchandise.

2. The method of claim 1 wherein the point of distribution is a retail store.

3. The method of claim 1, further comprising the steps of:
a) providing at least one customer with an account;
b) providing the customer with a card to enable the customer to charge purchases against the account, the card further comprising an RFID tag having customer-specific information;
c) electrically scanning the customer's merchandise selections at a check-out point of the store to obtain merchandise-specific information;
d) electrically scanning the customer's card to obtain the customer's account information;
e) obtaining personal identification information from the customer for verifying the customer's identity;
f) upon verification of the customer's identity, providing the customer with the option of at least one of charging the selections to the customer's account, writing a check, and paying cash; and
g) maintaining a record of customer-specific purchases.

4. A method for selling articles in a retail store, comprising the steps of:
a) providing at least one customer with an account;
b) providing the customer with a card to enable the customer to charge purchases against the account, the card further comprising an RFID tag having customer-specific information;
c) electrically scanning the customer when the customer is in proximity to a display to obtain the customer's identity and account information from the RFID tag; and
d) providing a customer-specific message to the customer via the display.

5. The method of claim 4 wherein the customer-specific message is a personalized greeting.

6. The method of claim 4 wherein the customer-specific message is an advertisement corresponding to the customer's past purchasing preferences.

7. A method for tracking and disposition of articles, comprising the steps of:
a) coding at least one RFID tag with a unique identifier, the identifier being electronically stored in a memory portion of the RFID tag;
b) affixing at least one RFID tag to at least one article of merchandise;
c) writing to a select RFID tag to set a status code indicating that the merchandise is unsold;
d) electrically scanning the select RFID tag to obtain the select identifier;
e) communicating the select identifier to an inventory record of a store and incrementing an inventory quantity of the store;
f) electrically scanning the article of merchandise when it is sold to obtain the select identifier from the RFID tag;
g) writing to the select RFID tag to change the status code to indicate that the merchandise has been sold; and
h) removing the select identifier from the inventory record and decrementing the inventory quantity.

8. A method according to claim 7, further comprising the steps of:
a) scanning a select RFID tag placed in proximity to an entry and/or exit point of the store to obtain the identifier information for the select RFID tag;
b) comparing the identifier information of the select RFID tag to the inventory record; and
c) generating a perceivable alert signal if the select RFID tag is listed in the inventory record.

9. A method according to claim 7, further comprising the steps of:
a) scanning a select RFID tag placed in proximity to an entry and/or exit point of the store to obtain the status code information for the select RFID tag; and
b) generating a perceivable alert signal if the status code indicates that the merchandise affixed to the select RFID tag is unsold.

10. A method for tracking and disposition of articles, comprising the steps of:
a) maintaining a record of the identifiers of RFID tags corresponding to unsold merchandise no longer in a store's inventory record;
b) electrically scanning the entrances and/or exits to the store for the identifiers of all RFID tags in proximity to the entrances and/or exits;
c) when a select RFID tag is detected, electrically scanning the RFID tag to obtain the identifier of the tag;
d) comparing the identifier of the each of the RFID tags to the store's record of unsold merchandise; and
e) generating an perceivable alert signal if the comparison of any of the identifiers of RFID tags match those of unsold merchandise.
